(19) United States
(12) Patent Application Publication
(10) Pub. No.: US 2025/0147497 A1
(43) Pub. Date: May 8, 2025

(54) PREDICTIVE HUMAN RESPONSE TERMINAL IN AN INDUSTRIAL AUTOMATION SYSTEM

(71) Applicant: Rockwell Automation Technologies, Inc., Mayfield Heights, OH (US)

(72) Inventor: John W. Miller, Waterford, MI (US)

(21) Appl. No.: 18/500,448

(22) Filed: Nov. 2, 2023

(51) Int. Cl. G05B 19/418

(52) U.S. Cl. CPC G05B 19/4188; G05B 2219/23023

(57) ABSTRACT

Systems and methods of this disclosure may enable operations that include receiving, via a processor, an indication of a user identifier from an input device associated with a human machine interface terminal (HMI). The processor may identify a user type corresponding to the user identifier. The processor may generate HMI visualization data based on the user type, the user identifier, and a presentation priority data structure. The presentation priority data structure may include presentation priority data corresponding to the user type and the user identifier, which may enable the processor to adjust which subsets of multiple screens are presented to the operator via an HMI based on preferences indicated via the presentation priority data.

### BACKGROUND

This disclosure generally relates to systems and methods for human-machine interface (HMI) presentation within industrial automation systems. More particularly, embodiments of the present disclosure are directed toward adjusting the HMI presentation based on inputs received via the HMI.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light and not as admissions of prior art.

Industrial automation systems may include automation control and monitoring systems. The automation control and monitoring systems may monitor statuses and/or receive sensing data from a wide range of devices, such as valves, electric motors, various types of sensors, other suitable monitoring devices, or the like. In addition, one or more components of the automation control and monitoring systems, such as programming terminals, automation controllers, input/output (IO) modules, communication networks, human-machine interface (HMI) terminals, and the like, may use the statuses and/or collected information to provide alerts to operators to change or adjust an operation of one or more components of the industrial automation system (e.g., such as adjusting operation of one or more actuators), to manage the industrial automation system, or the like. Some terminals, like HMI terminals (referred to herein as a “HMI” or as a “human machine interface”), may be accessed by a user to receive the various statuses, information, and/or alerts. However, information presented by default via the terminals may not be tailored to that user. The user may instead navigate to the information they wish to view, which may lead to computing resources being spent to enable the screen navigation.

### SUMMARY

A summary of certain embodiments disclosed herein is set forth below. It should be understood that these aspects are presented merely to provide the reader with a brief summary of these certain embodiments and that these aspects are not intended to limit the scope of this present disclosure. Indeed, this present disclosure may encompass a variety of aspects that may not be set forth below.

In one embodiment, a method may include receiving, via a processor of a human machine interface (HMI) communicatively coupled to an industrial automation device, an indication of a user identifier from an input device. The HMI may present one or more visualizations that communicate sensed data, a status, or both associated with an operation of the industrial automation device. The method may include identifying, via the processor, a user type corresponding to the user identifier based on a user type data structure. The user type data structure may characterize a dataset stored in a memory component accessible to the processor. Each of multiple user identifiers may be categorized with respect to user types, which may include an operator user type, a set-up user type, an engineer user type, a maintenance user type, an administrator user type, or any combination thereof. The method may include generating, via the processor, HMI visualization data based on the user type, the user identifier, and a presentation priority data structure. The presentation priority data structure may include presentation priority data corresponding to the user type and the user identifier. The method may include sending, via the processor, a control signal to a display to cause presentation of the HMI visualization data.

In another embodiment, a tangible, non-transitory, computer-readable medium may include instructions that, when executed by a processor, causes a human machine interface (HMI) terminal to perform operations. The operations may include receiving an indication of a first user identifier from an input device of an industrial automation device while a first visualization is presented that communicates sensing data, a status, or both associated with an operation of the industrial automation device. The operations may include identifying a first user type corresponding to the first user identifier based on a user type data structure. The user type data structure may characterize a dataset stored in a memory component accessible to the processor. Each of multiple user identifiers may be categorized with respect to multiple user types, which may include an operator user type, a set-up user type, an engineer user type, a maintenance user type, an administrator user type, or any combination thereof. The operations may include generating first HMI visualization data that causes presentation of a second visualization generated based on the first user type, the first user identifier, and a presentation priority data structure. The presentation priority data structure may include first presentation priority data corresponding to the first user type and the first user identifier. The operations may include sending a control signal to a display to cause presentation of the first HMI visualization data.

In yet another embodiment, a tangible, non-transitory, computer-readable medium may include instructions that, when executed by a processor, causes an industrial control device to perform operations. The operations may include generating first visualization data that causes presentation of a first visualization corresponding to a first set of screens. The first visualization may communicate sensing data, a status, or both associated with an operation of an industrial automation device. The operations may include receiving an indication of a user identifier from an input device of an industrial automation device while the first visualization is presented. The operations may include identifying a user type corresponding to the user identifier based on a user type data structure. The user type data structure may characterize a dataset stored in a memory component accessible to the processor. Each of user identifiers may be categorized with respect to user types that include an operator user type, a set-up user type, an engineer user type, a maintenance user type, an administrator user type, or any combination thereof. The operations may include determining a second set of screens based on the user type, the user identifier, and a presentation priority data structure. The presentation priority data structure may include presentation priority data corresponding to the user type and the user identifier. The operations may include generating second visualization data that causes presentation of a second visualization including the second set of screens.

### BRIEF DESCRIPTION OF THE DRAWINGS

These and other features, aspects, and advantages of the present disclosure may become better understood when the following detailed description is read with reference to the accompanying drawings in which like characters represent like parts throughout the drawings, wherein:

FIG. 1 is a block diagram of an example industrial automation system employed by a food manufacturer, in accordance with an embodiment;

FIG. 2 is a diagrammatic representation of a control and monitoring system and a human machine interface (HMI) that may be used in the industrial automation system of FIG. 1, in accordance with an embodiment;

FIG. 3 is a block diagram of example components of the HMI of FIG. 2 or other suitable industrial automation device, in accordance with an embodiment;

FIG. 4 is a diagrammatic representation of a user type (UT) data structure, which may be stored in memory of FIG. 3, in accordance with an embodiment;

FIG. 5 is a diagrammatic representation of a presentation priority (PP) data structure, which may be stored in the memory of FIG. 3, in accordance with an embodiment;

FIG. 6 is a flow chart of a method performed by the processor of FIG. 3 to generate output preference data used to generate HMI visualization data based on the UT data structure of FIG. 4 and/or the PP data structure of FIG. 5 and to generate preference data to be stored in the PP data structure of FIG. 5 based on inputs received while the HMI visualization is presented, in accordance with an embodiment;

FIG. 7 is a diagrammatic representation of operations performed by the processor of FIG. 3 to generate the HMI visualization data of FIG. 6, in accordance with an embodiment;

FIG. 8 is a diagrammatic representation of a first HMI visualization of FIGS. 6-7, the first HMI visualization corresponding to an operator user type and a user identifier “Smittie,” in accordance with an embodiment;

FIG. 9 is a diagrammatic representation of a second HMI visualization of FIGS. 6-7, the second HMI visualization corresponding to an operator user type, in accordance with an embodiment;

FIG. 10 is a diagrammatic representation of a third HMI visualization of FIGS. 6-7, the third HMI visualization corresponding to a set-up user type, in accordance with an embodiment;

FIG. 11 is a diagrammatic representation of a fourth HMI visualization of FIGS. 6-7, the fourth HMI visualization corresponding to an engineer user type, in accordance with an embodiment;

FIG. 12 is a diagrammatic representation of a fifth HMI visualization of FIGS. 6-7, the fifth HMI visualization corresponding to an administrator user type, in accordance with an embodiment;

FIG. 13 is a diagrammatic representation of a sixth HMI visualization of FIGS. 6-7, the sixth HMI visualization corresponding to a maintenance user type, in accordance with an embodiment;

FIG. 14 is a diagrammatic representation of a seventh HMI visualization of FIGS. 6-7, the seventh HMI visualization corresponding to an overlaid visualization that expands a quadrant of the HMI visualization, in accordance with an embodiment;

FIG. 15 is a diagrammatic representation of operations performed by the processor of FIG. 3 to generate the HMI visualization data of FIG. 6 and output preference data to change data stored in the PP data structure based on input data, in accordance with an embodiment; and

FIG. 16 is a diagrammatic representation of operations performed by the processor of FIG. 3 to generate the output preference data of FIG. 15 based on input data and gain data, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions are made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure is generally directed towards systems and methods associated with a Human Response Terminal (HRT), which may be a human machine interface (HMI) terminal (“HMI” herein) that provides visualizations on a display in association with an industrial automation device, such as a motor, drive, or the like, and based on operator input data to guide which subset of visualizations to be presented to that operator. The HMI may be used by a variety of different types of operators for a variety of different purposes. Some operators may be set-up operators that interface with the HMI to determine information to aid installation of a device while some operators may be administrator operators that access the HMI to determine information related to administration of the industrial automation system. These different operators and different operator types may have preferences regarding which order and type of information to be shown via the HMI.

An HMI may present, via its display, a visualization that includes a default arrangement of quadrant visualizations and/or less information than what is depicted herein, such as one rather than four quadrant visualizations. When this visualization is presented, an operator may interact with the display to change the HMI visualization to their liking. Thus, relatively greater amounts of computing resources may be consumed through a processor adjusting the HMI visualizations to respond to the inputs that attempt to change or correct what information is presented via that HMI. Systems and methods that increase efficiencies of HMI presentation to operators may reduce computing resources consumed, and thus improve operation of the industrial automation system.

Indeed, an operator may be associated with a user identifier, such as a user identifier used to log in to access information of the HMI and/or to change settings associated with industrial automation device operation via the HMI. The HMI may access a user type (UT) data structure and a presentation priority (PP) data structure to determine what user type corresponds to the operator and any presentation priority data associated with the user identifier and/or the user type (and thus corresponding to the operator). Once the HMI has this data, the HMI may generate visualizations customized for the operator. Over time, the HMI may receive user inputs when HMI visualizations are presented. The HMI may adjust data included in the PP data structure based on the user inputs for that operator or spanning the type of operator to compensate preferences based on actual input data of operators.

Implementing these systems and methods may improve HMI generation technologies. Indeed, by generating HMI visualizations that are tailored to a user identifier and/or a user type of that operator, the operator may use fewer inputs and thus reduced amounts of computing resources consumed by the processor to respond to the operator inputs. When fewer computing resources are consumed by the processor, fewer power is consumed overall, leading to reductions in energy consumption and/or permitting the unused computing resources to be dedicated to higher powered processing tasks, like predictive analytics, or other software-based operations.

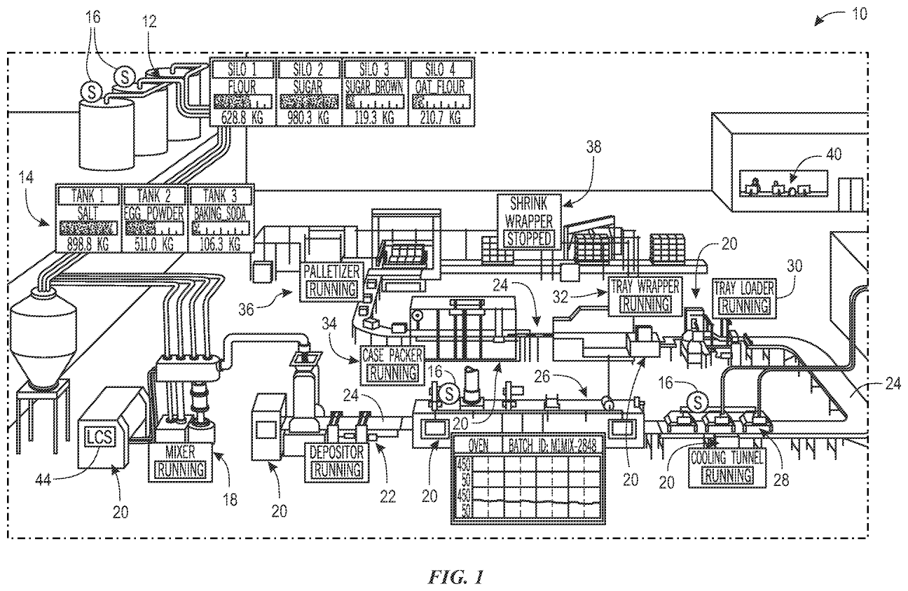

By way of introduction, FIG. 1 illustrates an example industrial automation system 10 employed by a food manufacturer. It should be noted that although the example industrial automation system 10 of FIG. 1 is directed at a food manufacturer, the present embodiments described herein may be employed within any suitable industry, such as automotive, mining, hydrocarbon production, manufacturing, and the like. The following brief description of the example industrial automation system 10 employed by the food manufacturer is provided herein to help facilitate a more comprehensive understanding of how the embodiments described herein may be applied to industrial devices to significantly improve the operations of the respective industrial automation system. As such, the embodiments described herein should not be limited to be applied to the example depicted in FIG. 1.

Referring now to FIG. 1, the example industrial automation system 10 for a food manufacturer may include silos 12 and tanks 14. The silos 12 and the tanks 14 may store different types of raw material, such as grains, salt, yeast, sweeteners, flavoring agents, coloring agents, vitamins, minerals, and preservatives. In some embodiments, sensors 16 may be positioned within or around the silos 12, the tanks 14, or other suitable locations within the industrial automation system 10 to measure certain properties, such as temperature, mass, volume, pressure, humidity, and the like.

The raw materials may be provided to a mixer 18, which may mix the raw materials together according to a specified ratio. The mixer 18 and other machines in the industrial automation system 10 may employ certain industrial automation devices 20 to control the operations of the mixer 18 and other machines. The industrial automation devices 20 may include controllers, input/output (I/O) modules, motor control centers, motors, human machine interfaces (HMIs), operator interfaces, contactors, starters, sensors 16, actuators, conveyors, drives, relays, protection devices, switchgear, compressors, sensor, actuator, firewall, network switches (e.g., Ethernet switches, modular-managed, fixed-managed, service-router, industrial, unmanaged, etc.) and the like.

The mixer 18 may provide a mixed compound to a depositor 22, which may deposit a certain amount of the mixed compound onto conveyor 24. The depositor 22 may deposit the mixed compound on the conveyor 24 according to a shape and amount that may be specified to a control system for the depositor 22. The conveyor 24 may be any suitable conveyor system that transports items to various types of machinery across the industrial automation system 10. For example, the conveyor 24 may transport deposited material from the depositor 22 to an oven 26, which may bake the deposited material. The baked material may be transported to a cooling tunnel 28 to cool the baked material, such that the cooled material may be transported to a tray loader 30 via the conveyor 24. The tray loader 30 may include machinery that receives a certain amount of the cooled material for packaging. By way of example, the tray loader 30 may receive 25 ounces of the cooled material, which may correspond to an amount of cereal provided in a cereal box.

A tray wrapper 32 may receive a collected amount of cooled material from the tray loader 30 into a bag, which may be sealed. The tray wrapper 32 may receive the collected amount of cooled material in a bag and seal the bag using appropriate machinery. The conveyor 24 may transport the bagged material to case packer 34, which may package the bagged material into a box. The boxes may be transported to a palletizer 36, which may stack a certain number of boxes on a pallet that may be lifted using a forklift or the like. The stacked boxes may then be transported to a shrink wrapper 38, which may wrap the stacked boxes with shrink-wrap to keep the stacked boxes together while on the pallet. The shrink-wrapped boxes may then be transported to storage or the like via a forklift or other suitable transport vehicle.

To perform the operations of each of the devices in the example industrial automation system 10, the industrial automation devices 20 may be used to provide power to the machinery used to perform certain tasks, provide protection to the machinery from electrical surges, prevent injuries from occurring with human operators in the industrial automation system 10, monitor the operations of the respective device, communicate data regarding the respective device to a supervisory control system 40, and the like. In some embodiments, each industrial automation device 20 or a group of industrial automation devices 20 may be controlled using a local control system 42. The local control system 42 may include receive data regarding the operation of the respective industrial automation device 20, other industrial automation devices 20, user inputs, and other suitable inputs to control the operations of the respective industrial automation device(s) 20.

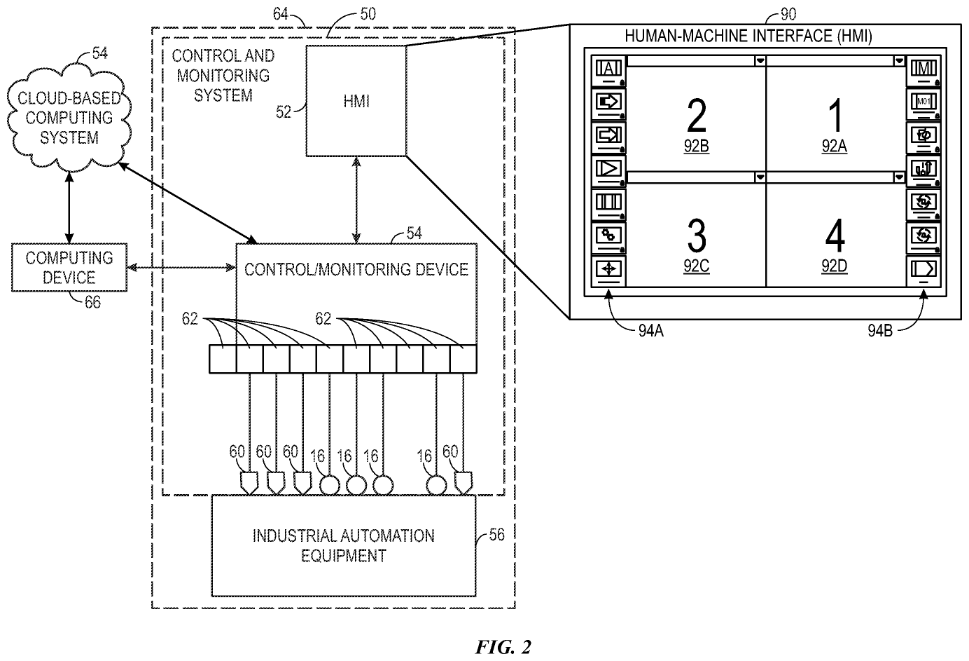

By way of example, FIG. 2 illustrates a diagrammatical representation of an exemplary control and monitoring system 50 that may be employed in any suitable industrial automation system 10. In FIG. 2, the control and monitoring system 50 is illustrated as including a human machine interface terminal (HMI) 52 and a control/monitoring device 54 or automation controller adapted to interface with devices that may monitor and control various types of industrial automation equipment 56. The HMI 52, the control/monitoring device 54, programmable logic controllers, or the like may be considered industrial control devices. By way of example, the industrial automation equipment 56 may include the mixer 18, the depositor 22, the conveyor 24, the oven 26, and the other pieces of machinery described in FIG. 1.

It should be noted that the HMI 52 and the control/monitoring device 54, in accordance with embodiments of the present techniques, may be facilitated by the use of certain network strategies. Indeed, an industry standard network may be employed, such as DeviceNet, to enable data transfer. Such networks permit the exchange of data in accordance with a predefined protocol, and may provide power for operation of networked elements.

The industrial automation equipment 56 may take many forms and include devices for accomplishing many different and varied purposes. For example, the industrial automation equipment 56 may include machinery used to perform various operations in a compressor station, an oil refinery, a batch operation for making food items, a mechanized assembly line, and so forth. Accordingly, the industrial automation equipment 56 may comprise a variety of operational components, such as electric motors, valves, actuators, temperature elements, pressure sensors, or a myriad of machinery or devices used for manufacturing, processing, material handling, and other applications.

The industrial automation equipment 56 may include various types of equipment that may be used to perform the various operations that may be part of an industrial application. For instance, the industrial automation equipment 56 may include electrical equipment, hydraulic equipment, compressed air equipment, steam equipment, mechanical tools, protective equipment, refrigeration equipment, power lines, hydraulic lines, steam lines, and the like. Some example types of equipment may include mixers, machine conveyors, tanks, skids, specialized original equipment manufacturer machines, and the like. In addition to the equipment described above, the industrial automation equipment 56 may be made up of certain automation devices 20, which may include controllers, input/output (I/O) modules, motor control centers, motors, human machine interfaces (HMIs), operator interfaces, contactors, starters, sensors 16, actuators, drives, relays, protection devices, switchgear, compressors, firewall, network switches (e.g., Ethernet switches, modular-managed, fixed-managed, service-router, industrial, unmanaged, etc.) and the like.

One or more properties of the industrial automation equipment 56 may be monitored and controlled by certain equipment for regulating control variables used to operate the industrial automation equipment 56. For example, the sensors 16 and actuators 60 may monitor various properties of the industrial automation equipment 56 and may adjust operations of the industrial automation equipment 56, respectively.

The industrial automation equipment 56 may be associated with devices used by other equipment. For instance, scanners, gauges, valves, flow meters, and the like may be disposed on industrial automation equipment 56. Here, the industrial automation equipment 56 may receive data from the associated devices and use the data to perform their respective operations more efficiently. For example, a controller (e.g., control/monitoring device 54) of a motor drive may receive data regarding a temperature of a connected motor and may adjust operations of the motor drive based on the data.

The industrial automation equipment 56 may include a communication component that enables the industrial automation equipment 56 to communicate data between each other and other devices. The communication component may include a network interface that may enable the industrial automation equipment 56 to communicate via various protocols such as Ethernet/IP®, ControlNet®, DeviceNet®, or any other industrial communication network protocol. Alternatively, the communication component may enable the industrial automation equipment 56 to communicate via various wired or wireless communication protocols, such as Wi-Fi, mobile telecommunications technology (e.g., 2G, 3G, 4G, LTE), Bluetooth®, near-field communications technology, and the like.

The sensors 16 may be any number of devices adapted to provide information regarding process conditions. The actuators 60 may include any number of devices adapted to perform a mechanical action in response to a signal from a control system (e.g., the control/monitoring device 54). The sensors 16 and actuators 60 may be utilized to operate the industrial automation equipment 56. Indeed, they may be utilized within process loops that are monitored and controlled by the control/monitoring device 54 and/or the HMI 52. Such a process loop may be activated based on process inputs (e.g., input from a sensor 16) or direct operator input received through the HMI 52. As illustrated, the sensors 16 and actuators 60 are in communication with the control/monitoring device 54. Further, the sensors 16 and actuators 60 may be assigned a particular address in the control/monitoring device 54 and receive power from the control/monitoring device 54 or attached modules.

Input/output (I/O) modules 62 may be added or removed from the control and monitoring system 50 via expansion slots, bays or other suitable mechanisms. In certain embodiments, the I/O modules 62 may be included to add functionality to the control/monitoring device 54, or to accommodate additional process features. For instance, the I/O modules 62 may communicate with new sensors 16 or actuators 60 added to monitor and control the industrial automation equipment 56. It should be noted that the I/O modules 62 may communicate directly to sensors 16 or actuators 60 through hardwired connections or may communicate through wired or wireless sensor networks, such as Hart or IO Link.

The I/O modules 62 serve as an electrical interface to the control/monitoring device 54 and may be located proximate or remote from the control/monitoring device 54, including remote network interfaces to associated systems. In such embodiments, data may be communicated with remote modules over a common communication link, or network, wherein modules on the network communicate via a standard communications protocol. Many industrial controllers can communicate via network technologies such as Ethernet (e.g., IEEE802.3, TCP/IP, UDP, Ethernet/IP, and so forth), ControlNet, DeviceNet or other network protocols (Foundation Fieldbus (H1 and Fast Ethernet) Modbus TCP, Profibus) and also communicate to higher level computing systems.

Several of the I/O modules 62 may transfer input and output signals between the control/monitoring device 54 and the industrial automation equipment 56. As illustrated, the sensors 16 and actuators 60 may communicate with the control/monitoring device 54 via one or more of the I/O modules 62 coupled to the control/monitoring device 54.

The control and monitoring system 50 (e.g., the HMI 52, the control/monitoring device 54, the sensors 16, the actuators 60, the I/O modules 62) and the industrial automation equipment 56 may make up an industrial automation application 64. The industrial automation application 64 may involve any type of industrial process or system used to manufacture, produce, process, or package various types of items. For example, the industrial automation applications 64 may include industries such as material handling, packaging industries, manufacturing, processing, batch processing, the example industrial automation system 10 of FIG. 1, and the like.

The control/monitoring device 54 may be communicatively coupled to a computing device 66 and a cloud-based computing system 68. In this network, input and output signals generated from the control/monitoring device 54 may be communicated between the computing device 66 and the cloud-based computing system 68. The control/monitoring device 54 may include one or more components described in FIG. 3 and thus may include a software application stored in its memory. When executed by processing circuitry of the control/monitoring device 54, the processor may enable the control/monitoring device 54 to perform various functionalities, such as tracking statistics of the industrial automation equipment 56, storing reasons for placing the industrial automation equipment 56 offline, determining reasons for placing the industrial automation equipment 56 offline, securing industrial automation equipment 56 that is offline, denying access to place an offline industrial automation equipment 56 back online until certain conditions are met, and so forth.

Although the control/monitoring device 54 may be capable of communicating with the computing device 66 and the cloud-based computing system 68, as mentioned above, in certain embodiments, the control/monitoring device 54 (e.g., local control system 42) may perform certain operations and analysis without sending data to the computing device 66 or the cloud-based computing system 68.

FIG. 3 illustrates example components that may be part of one or more components of FIG. 2, such as the HMI 52 or the control/monitoring device 54. For example, the HMI 52 may include a communication component 72, a processor 74, a memory 76 (e.g., one or more memory components), a storage 78, input/output (I/O) ports 80, a display 86, additional sensors (e.g., vibration sensors, temperature sensors), and the like. The communication component 72 may be a wireless or wired communication component that may facilitate communication between the industrial automation equipment 56, the cloud-based computing system 68, and other communication capable devices.

The processor 74 may be any type of computer processor or microprocessor capable of executing computer-executable code. The processor 74 may also include multiple processors that may perform the operations described below. The memory 76 and the storage 78 may be any suitable articles of manufacture that can serve as media to store processor-executable code, data, or the like. These articles of manufacture may represent computer-readable media (e.g., any suitable form of memory or storage) that may store the processor-executable code used by the processor 74 to perform the presently disclosed techniques. For example, preference processing operations described herein.

The memory 76 and the storage 78 may also be used to store the data, analysis of the data, the software applications, and the like. The memory 76 and the storage 78 may represent non-transitory computer-readable media (e.g., any suitable form of memory or storage) that may store the processor-executable code used by the processor 74 to perform various techniques described herein. It should be noted that non-transitory merely indicates that the media is tangible and not a signal.

The memory 76 and/or storage 78 may include a software application that may be executed by the processor 74 and may be used to perform monitoring, control, or processing operations, such as those described herein. In some cases, the computing device 66 of FIG. 2 may communicatively couple to industrial automation equipment 56 or to a respective computing device of the industrial automation equipment 56 via a direct connection between the devices or via the cloud-based computing system 58. Coupling between the control/monitoring device 54 and the HMI 52 may enable data generated by the HMI 52 to transmit to one or more computing devices 66 and/or the cloud-based computing system 68.

The I/O ports 80 may be interfaces that may couple to other peripheral components such as input devices (e.g., keyboard, mouse), sensors, input/output (I/O) modules, and the like. I/O modules may enable the computing device 66 or other control/monitoring devices 54 to communicate with the industrial automation equipment 56 or other devices in the industrial automation system via the I/O modules.

The display 86 may depict visualizations associated with software or executable code being processed by the processor 74 in response to one or more control signals generated by the processor 74 and in response to image data. The image data may be generated by the processor 74 and/or accessed by the processor 74 from memory, such as when visualizations are presented based on design files generating via the computing device 66 and/or the cloud-based computing system 68. In one embodiment, the display 86 may be a touch display capable of receiving inputs (e.g., parameter data for operating the industrial automation equipment 56) from a user of the control/monitoring device 54. As such, the display 86 may serve as a user interface to communicate with the industrial automation equipment 56. The display 86 may be used to display a graphical user interface (GUI) for operating the industrial automation equipment 56, for tracking the maintenance of the industrial automation equipment 56, and the like. The display 86 may be any suitable type of display, such as a liquid crystal display (LCD), plasma display, or an organic light emitting diode (OLED) display. The display 86 may be provided in conjunction with a touch-sensitive mechanism (e.g., a touch screen) that may function as part of a control interface for the industrial automation equipment 56 or for a number of pieces of industrial automation equipment in the industrial automation application 64, to control the general operations of the industrial automation application 64. In some embodiments, the operator interface may be characterized as the HMI 52, a human-interface machine, or the like.

Although the components described above have been discussed with regard to the HMI 52, it should be noted that similar components may make up other computing devices described herein. Further, it should be noted that the listed components are examples and the embodiments described herein are not to be limited to the components described with reference to FIG. 3.

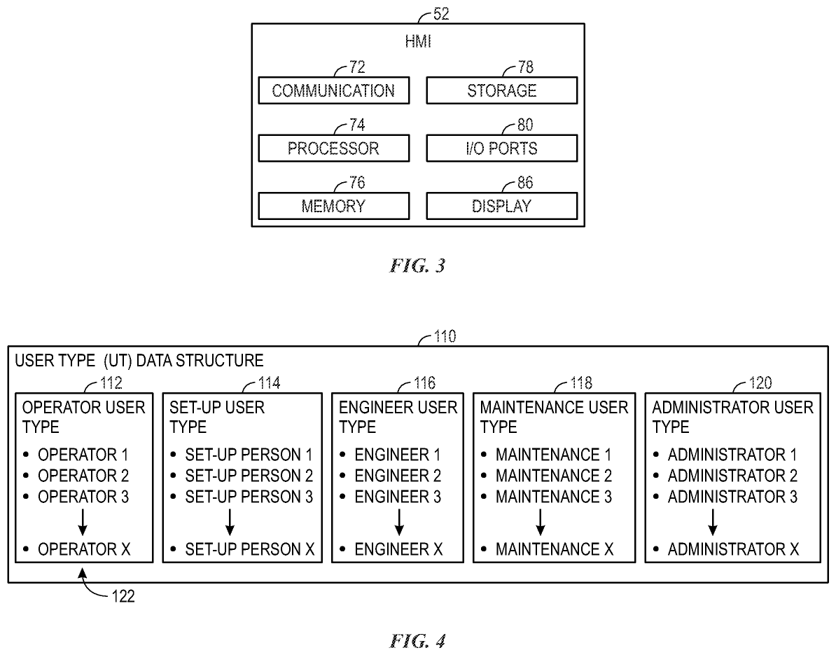

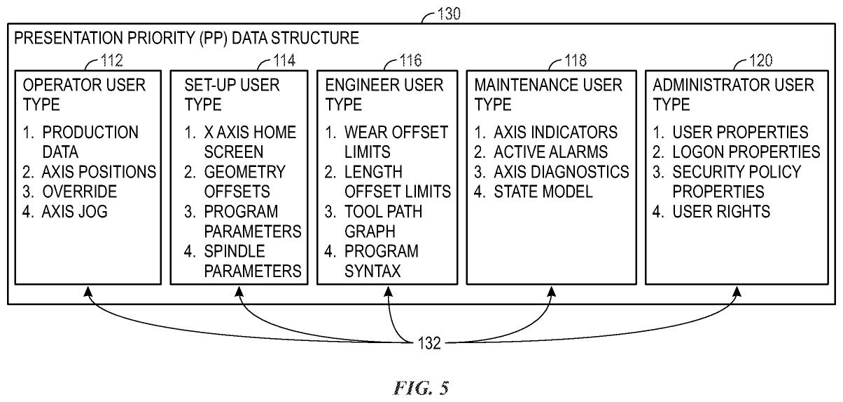

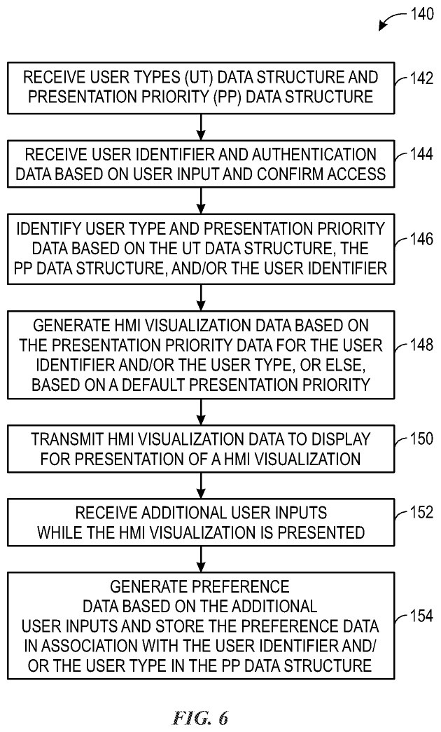

Referring to FIGS. 2 and 3 together, the HMI 52 may include the display 86 to present visualizations (e.g., HMI visualizations 90) within a dashboard graphical user interface (GUI). The HMI 52 may present HMI visualizations 90 based on respective quadrants visualizations 92 (quadrant visualization 92A, quadrant visualization 92B, quadrant visualization 92C, quadrant visualization 92D) and a border visualization 94 (border visualization 94A, border visualization 94B). An operator may access the HMI 52 to be presented information regarding the industrial automation equipment 56, such information may include data, alerts, statuses generated by the control/monitoring device 54. The HMI 52 (e.g., via processor 74) may access data associated with the operator and generate HMI visualizations 90 to be tailored to that operator. Data associated with the operator may be stored in a user type (UT) data structure (e.g., FIG. 4) and/or a presentation priority (PP) data structure (e.g., FIG. 5).

To elaborate, FIG. 4 is a diagrammatic representation of a user type (UT) data structure 110, which may be stored in memory 76. The UT data structure 110 may include indications associating a user identifier to a user type. Any number of user identifier and user type indications may be stored in the memory 76 in the UT data structure 110. In this illustrated example, the UT data structure 110 includes an operator user type 112, a set-up user type 114, an engineer user type 116, a maintenance user type 118, and an administrator user type 120, and each type is associated with one or more user identifiers 122. Indeed, user identifiers may be categorized with respect to a variety of user types (e.g., the operator user type 112, the set-up user type 114, the engineer user type 116, the maintenance user type 118, the administrator user type 120, or other suitable user types not described herein).

The operator user type 112 may be assigned to operators that change settings of the industrial automation equipment 56 as part of their role within the industrial automation system 10. The set-up user type 114 may be assigned to operators that install the industrial automation equipment 56 as part of their role within the industrial automation system 10. The engineer user type 116 may be assigned to operators that are engineers as their role within the industrial automation system 10 and thus may prioritize different information relative to, for example, the operator user type 112 since the engineer operator may not be concerned with day-to-day operational nuances of the industrial automation equipment 56, instead prioritizing longer-term performance information. The administrator user type 120 may be assigned to operators that are administrators as their role within the industrial automation system 10 and thus may prioritize different information relative to, for example, the operator user type 112.

Each user type 112-120 may have associated user identifiers 122, which correspond to respective operators. For example, the operator user type 112 is associated with the operator 1, operator 2, operator 3, . . . operator X user identifiers 122. When an operator identified by “operator 1” user identifier attempts to log into the HMI 52, the processor 74 may access the UT data structure 110 to determine that the operator identified by “operator 1” user identifier 112 corresponds to the operator user type 112.

FIG. 5 is a diagrammatic representation of a presentation priority (PP) data structure 130, which may be stored in the memory 76. The PP data structure 130 may include indications of user types and associated presentation priority data. The PP data structure 130 may include data corresponding to the same user types of the UT data structure 110. In this illustrated example, the PP data structure 130 includes presentation priority data for each of the operator user type 112, the set-up user type 114, the engineer user type 116, the maintenance user type 118, and the administrator user type 120. Other user types and/or user identifiers may be included in an example UT data structure 110 and/or a PP data structure 130. In the case were one of the user types 112-120 is not associated with presentation priority data, the portion of the PP data structure 130 corresponding to that user type may include null data, which may be overwritten once presentation priority data is generated by the HMI 52.

Each user type 112-120 may have associated presentation priority data 132, which correspond to respective operators. For example, the operator user type 112 may correspond to presentation priority data that prioritizes presentation of “1. Production Data 2. Axis Positions 3. Override 4. Axis Jog” over other visualizations corresponding to, for example, “X Axis Home Screen” or “Length Offset Limits,” which were prioritized for the set-up user type 114 and the engineer user type 116, respectively. For ease of disclosure, each combination of presentation priority data is not called herein (e.g., see such examples in FIG. 5). It is noted that FIG. 5 and FIGS. 9-14 include examples of the various visualization examples described herein as well as types of data that may be presented to an operator via the visualizations.

The HMI 52 may access the UT data structure 110 and/or PP data structure 130 in its local memory 76. The UT data structure 110 and/or the PP data structure 130 may be accessed via the control/monitoring device 54 from the cloud-based computing system 68 and/or the computing device 66. The HMI 52 may generate HMI visualizations based on data stored in the UT data structure 110 and/or PP data structure 130, as is described with FIG. 6.

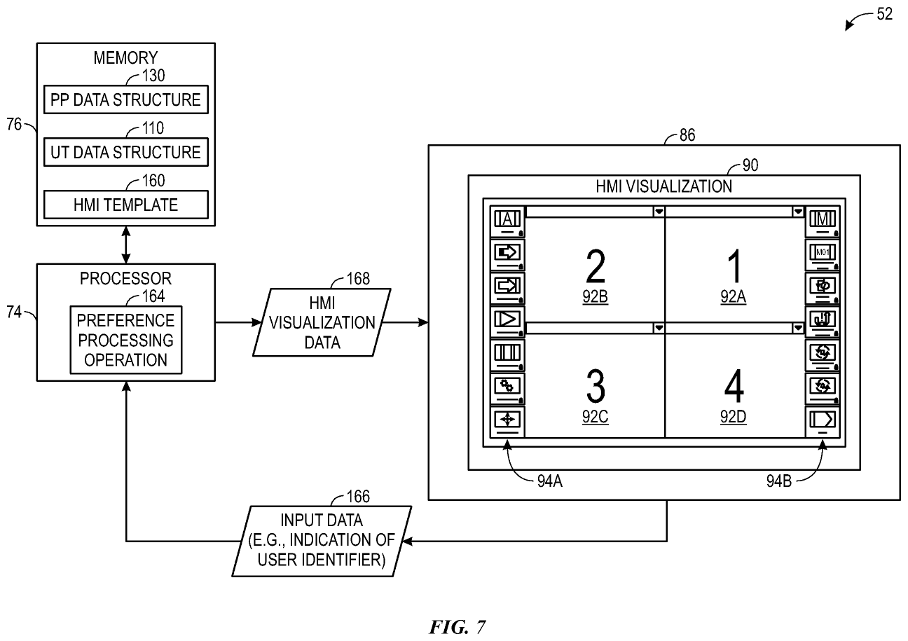

FIG. 6 is a flow chart of a method 140 performed by the processor 74 to generate HMI visualization data and to generate output preference data based on inputs received while the HMI visualization is presented. The method 140 is described as performed by the processor 74 associated with the HMI 52. The HMI 52 may communicatively couple to the industrial automation equipment 56. However, it should be understood that any suitable processing circuitry may perform some or all of the operations, such as processing circuitry of a programmable logic device or control/monitoring device 54. Although described in a particular order, which represents a particular embodiment, it should be noted that operations of the method 140 may be performed in any suitable order. Additionally, embodiments of the method 140 may omit process blocks and/or include additional process blocks. Moreover, in some cases the method 140 may be implemented at least in part by executing instructions stored in a tangible, non-transitory, computer-readable medium, such as memory 76 associated with the HMI 52. For ease of disclosure, the method 140 may refer to operations illustrated in FIG. 7 as well as other figures here. FIG. 7 is a diagrammatic representation of operations performed by the processor 74 to generate the HMI visualization data of the method 140. References between FIG. 6 and FIG. 7 may not be called out specifically herein. Indeed, FIGS. 6 and 7 are described together herein.

At block 142, the HMI 52, via the processor 74, may receive the UT data structure 110 and/or the PP data structure 130. The processor 74 may read the UT data structure 110 and/or the PP data structure 130 from the memory 76.

At block 144, the HMI 52, via the processor 74, may receive a user identifier from the display 86 (e.g., transmitted as part of the input data 166). The HMI 52 may present, via the display 86, one or more visualizations that communicate sensed data, a status, or both associated with an operation of the industrial automation equipment 56 (e.g., an example industrial automation device). The user identifier may correspond to a login attempt by an operator and thus be transmitted with authentication data (e.g., an indication of a password). Logging into the HMI 51 may enable selective presentation of potentially sensitive operating information associated with the industrial automation system 10 to the operators able to be authenticated to the HM1 52. The user identifier and/or authentication data may be determined and received based on input data 166. The processor 74 may confirm or validate the login attempt by the operator based on the combination of the user identifier and the authentication data, such as by confirming that it matches data stored in the memory 76 and/or that the user identifier corresponds to permissions that indicate authorization to access the HMI 52. The processor 74 may cause the display 86 to present default HMI visualizations before a session is started based on a user identifier. As will be appreciated herein, once the session is started based on the user identifier, the processor 74 may cause the display 86 to present HMI visualizations adjusted based on stored preferences and predictions made regarding content suitable for and/or preferred by an operator corresponding to that user identifier.

Indeed, at block 146, the HMI 52, via the processor 74, may identify a user type and presentation priority data based on the UT data structure 110, the PP data structure 130, and/or the user identifier (received as part of input data 166). The processor 74 may query the UT data structure 110 and/or perform a lookup operation to search the UT data structure 110 for the user identifier. Once found, the location within the UT data structure 110 where the user identifier is stored indicates the user type corresponding to the operator corresponding to that user identifier. The structure of the UT data structure 110 and PP data structure 130 may be such that relatively large datasets of user identifiers may be stored and associated with user types and preferences to enable relatively low querying complexity when performed by the processor 74. Storing preference data in association with user types and/or user identifiers in this way may reduce an amount of computing resources consumed when compared to accessing large document processing files. Based on the identified user type, at block 146, the processor 74 may perform the preference processing operation based on an indication of which of the various user types 112-120 the user identifier corresponds to and an indication of preferences corresponding to the user identifier and/or the user type. The indication of preferences (e.g., indications of expected preferences) for the operator that logged into the HMI 52 may be stored in the PP data structure 130 in association with the user identifier of that operator. The indication of preferences (e.g., indications of expected preferences) for the user type may be stored in the PP data structure 130 in association with the user type. By referencing both the PP data structure 130 and the UT data structure 110, the processor 74 may identify and prioritize preferences (or expected preferences) among preferences for the operator and preferences for the user type of the operator. The processor 74 may set a relatively higher priority to the preferences associated with the user identifier when compared to preferences associated with the user type.

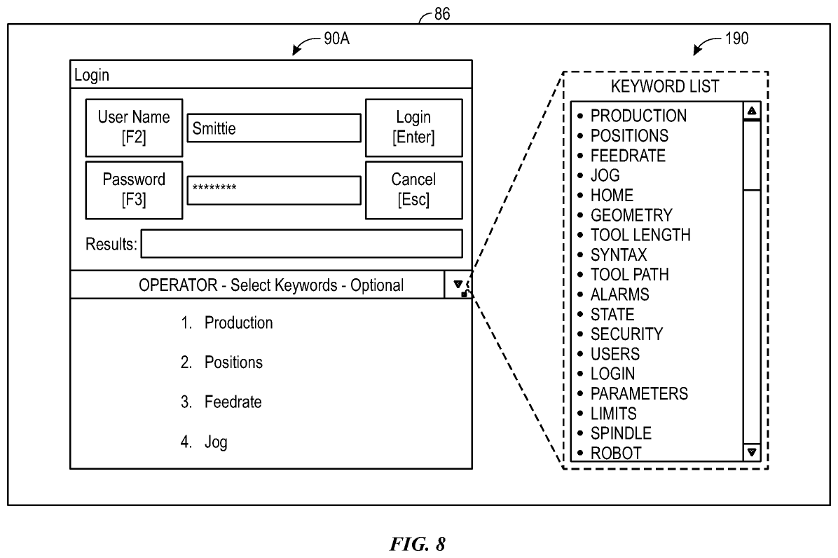

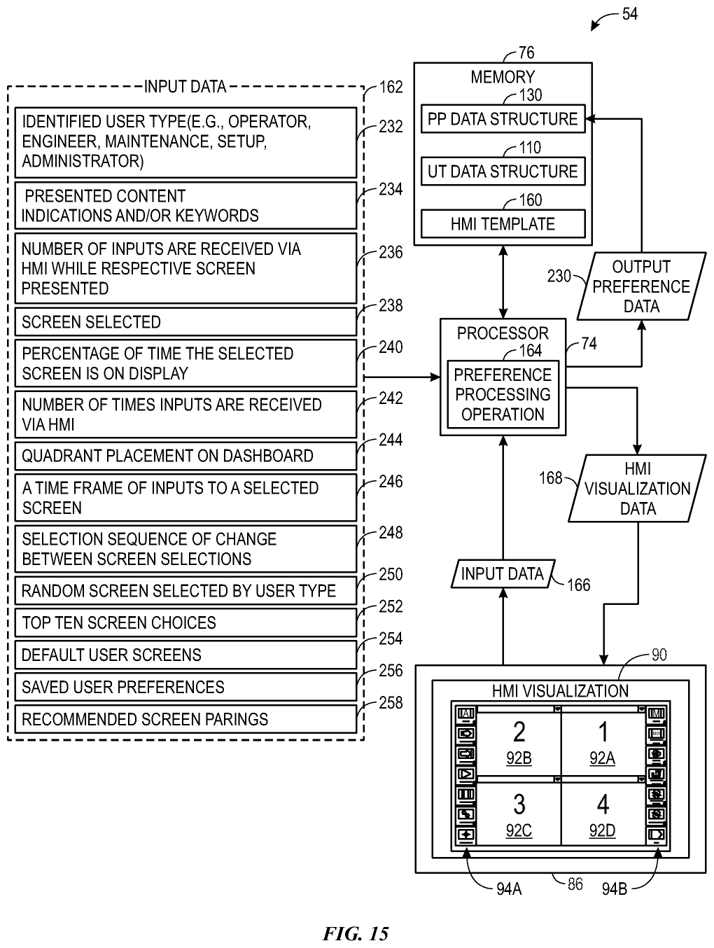

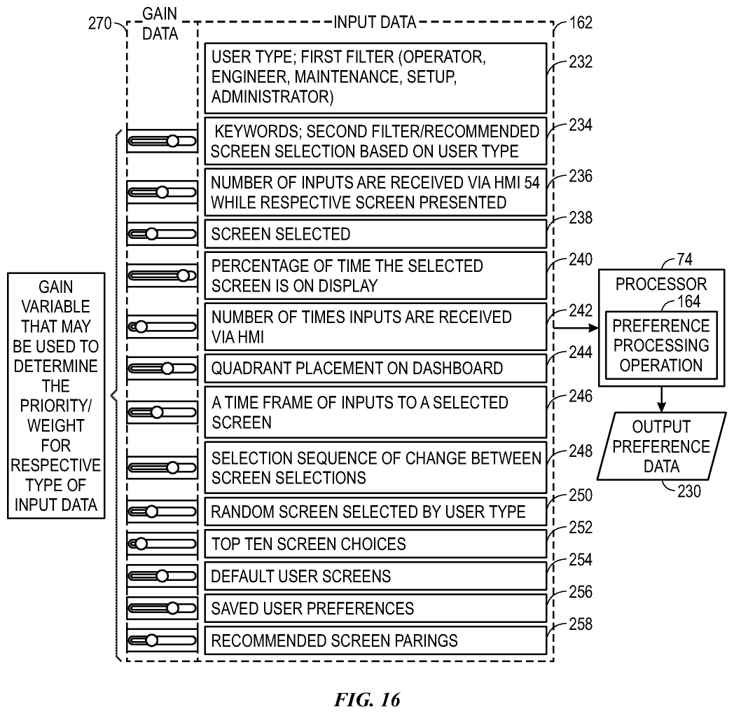

At block 148, the HMI 52, via the processor 74, may generate HMI visualization data 168 based on the presentation priority data for the user identifier and/or the user type, or else, based on an HMI template 160 stored in the memory 76. The HMI visualization data 168 may include image data corresponding to four quadrants of image content, where each respective quadrant may present a different screen. This enables N screens to be presented at one time, where N number corresponds to a number of display divisions related to a programming of the HMI 52 and/or the display 86. In this example, four screens are able to presented at one time via the four quadrant visualizations 92. Systems with more or fewer display divisions (e.g., halves, quadrants, thirds) may present a corresponding number of screens at one time. The HMI template 160 may be used when the PP data structure 130 is empty for a user type. When a user identifier is not associated with preference priority data in the memory 76, the processor 74 may generate the HMI visualization data 168 as corresponding to preferences associated with the user type corresponding to the user identifier. At block 150, the HMI 52, via the processor 74, may transmit the HMI visualization data 168 to the display 86 for presentation of an HMI visualization 90. Various examples of HMI visualizations are described herein with reference to FIGS. 8-14. Additional data that may be referenced when generating HMI visualization data 168 and/or presentation priority data is described herein at least with reference to FIGS. 15-16. These additional examples and descriptions may help illustrate how flexible these systems and methods are. For example, the presentation priority data may include an indication of a percentage of time a respective screen is presented in association with the user identifier, an indication of a quadrant placement of a respective screen in association with the user identifier, an indication of a frequency of inputs received via a respective screen in association with the user identifier, an indication of a total set of screens selected in association with the user identifier, or other suitable data.

At block 152, the HMI 52, via the processor 74, may receive additional input data 166 while the HMI visualization 90 is presented. The additional input data 166 may correspond to tactile inputs received via the display 86, such as which additional screens an input instructed the HMI 52 to load, timing associated with the inputs, a sequence of screens or information instructed the HMI 52 to load, or the like. At block 154, the HMI 52, via the processor 74, may generate preference data based on the additional input data 166 and store the preference data in association with the user identifier and/or the user type in the PP data structure 130. The processor 74 may generally perform the preference processing operation 164. Indeed, the preference processing operation 164 may update presentation priority data stored in the PP data structure 130 for that operator and/or that user type of that operator. Preferences determined for one operator may be used to alter preferences stored in the PP data structure 130 for one or more other operators that share a same user type. This may further reduce computing resources consumed by the HMI 52 over time since operators may no longer edit presentation preferences of HMI visualizations at each access to the HMI 52. These changes may be determined and stored over time.

To generate the HMI visualization data 168, the processor 74 may receive the input data 166 that includes the user type and generate HMI visualization data 168 based on current input data 166 and previously received input data 166, which may be used to generate preference data at block 154. The processor 74 may store in memory 76 indications of previously received input data 166 and determine when trends of inputs are received among different user identifiers and user types. The input data 166 may include indications of input locations received via the display 86 (e.g., locations where tactile inputs were received, selections corresponding to inputs received via physical input devices like buttons), timestamps associated with the inputs, or the like. The input data 166 may be processed by the processor 74 to generate second filter data. This second filter data may be a second level input data generated based on some of the input data 166 and may itself also be regarded as input data 166 for the purpose of explanations herein. It is noted that additional examples of input data 166 and/or second level data are described relative to FIG. 15.

In some cases, operations may include reading the memory 76 to access the PP data structure 130. The operations may include generating second level input data based the user type, the user identifier, and indications of input selections received during a session corresponding to the user identifier, and respective timestamps of each of the input selections. The operations of generating the second level input data may involve: comparing the input selections and the respective timestamps of each input selection of the input selections to one or more previously received inputs selections and respective timestamps of each input selection of the one or more received inputs selections; determining a number of times that a first screen is selected during the session corresponding to the user identifier; determining that the number of times that the first screen is selected during the session corresponding to the user identifier crosses a threshold number of selections; determining that a rate between selections of the first screen is less than a threshold rate; and generating the second level input data to indicate that the first screen is a determined to be a relatively preferred screen of the multiple screens based on the rate being less than a threshold rate and the number of times that the first screen is selected crosses a threshold number of selections. In some cases, alternative conditions and/or different thresholds may be used (e.g., such that the rate being greater than or equal to the threshold rate and/or crosses a threshold rate is the trigger). Sometimes, the second level input data may be used to change a selection of screens selected for the user identifier relative to a default set of screens presented for the user type and/or default set of screens presented to any operator prior to a session beginning. The processor 74 may overwrite one or more data (e.g., preexisting presentation priority data) of the PP data structure 130 based on the second level data, and in this way may iteratively change priorities relative to different screens (e.g., indications of preferred screens) for one or more operators, one or more user types, across one or more displays over time as input data is gathered across the industrial automation system 10.

While the HMI visualizations determined at block 148 are presented via the display 86, the processor 74 may receive input data 166. The processor 74 may retain data related to which subsets of screens are presented via the display 86. By comparing the subset of screens presented, the timestamps of respective inputs, and the locations of the respective inputs relative to where content of the subsets of screens are presented on the display 86, the processor 74 may determine which content and/or which respective screens are receiving relatively more being presented and an order of access for the subsets of screens. The processor 74 may prioritize respective screens based on which relative screens were presented for relative longer durations of time, which may correspond to an operator spending more time viewing the information presented via that screen. to the

HMI visualizations 90 may refer to a subset or relatively small visualization or image content rendered for presentation on the display 86, such as a drop-down menu or an icon, and/or may refer to one or more quadrants visualizations 90 of the display 86. Although several examples of HMI visualizations are described herein, it should be understood that any suitable image content may be generated for presentation on the display 86 as may be suitable to accommodate a wide variety of devices implemented in an industrial automation system. For example, a different number of subsets of the display 86 may be used in place of quadrants, such as halves, thirds, or the like. To elaborate, FIGS. 8-14 are some examples of HMI visualizations that the processor 74 may generate based on systems and methods described herein and based on FIGS. 6-7.

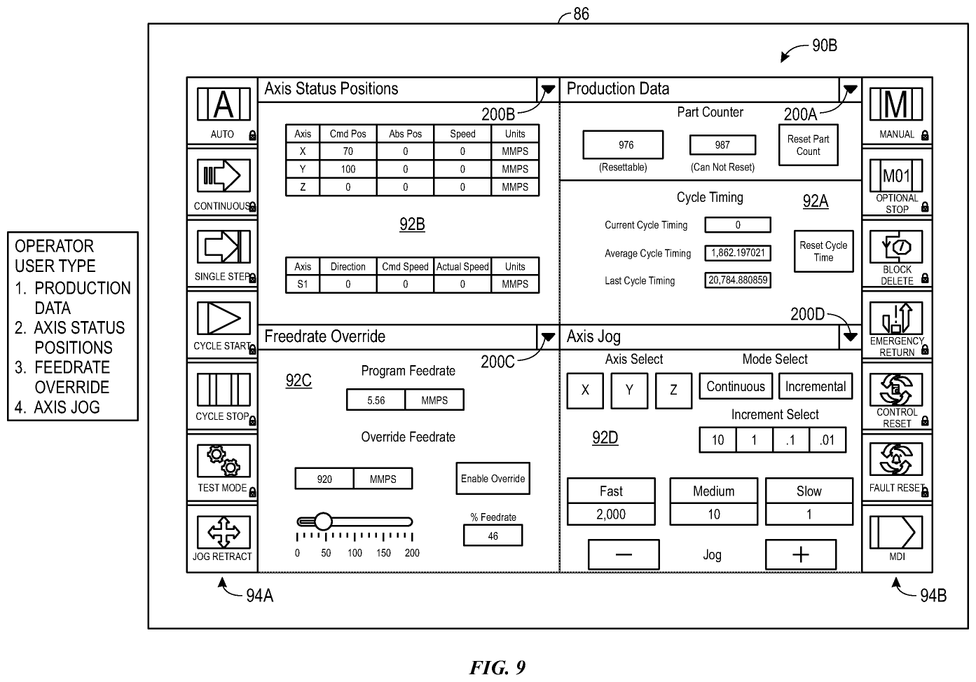

FIG. 8 is a diagrammatic representation of a first HMI visualization 90A of FIGS. 6-7, the first HMI visualization 90A corresponding to an operator user type and a user identifier “Smittie” received at block 144. FIG. 9 is a diagrammatic representation of a second HMI visualization 90B of FIGS. 6-7, the second HMI visualization corresponding to an operator user type. Since FIG. 8 and FIG. 9 both illustrate example HMI visualizations for the operator user type, these figures are described together herein.

Based on operations of blocks 146 and 148, the processor 74 may use the received user inputs and generate HMI visualization data 168 based on stored presentation priorities associated with the user identifier of “Smittie” and/or its corresponding user type of “operator.” Indeed, the processor 74 may generate the “Keyword List” visualization 190 based on indications of presentation priorities (e.g., preferences) obtained or determined for that user identifier of “Smittie.” The indications of presentation priority data is stored in the PP data structure 130 and/or determined by the processor 74 processing one or more types of input data from the HMI 52. The generated “Keyword List” 190 may visually sort and/or prioritize presentation of keywords deemed more suitable for the operator user type and/or the user identifier “Smittie” based on past input data associated with the operator user type and/or the user identifier “Smittie.” For example, “Smittie” corresponds to an operator user type and thus the processor 74 may present “Production,” “Positions,” “Feedrate,” and “Jog,” as the top keywords for that operator user type, which may correspond respectively to “Production Data” content, “Axis Status Positions” content, “Feedrate Override” content, and “Axis Jog” content of FIG. 9. If the user identifier “Smittie” was associated with different presentation priority data in the PP data structure 130 than the operator user type, the “Keyword List” 190 may further deviate from that presented for the operator user type.

To prioritize which data to be presented via the HMI 52, the processor 74 may analyze input data to determine which combinations of keywords resulted in a reduced amount of or the relatively lowest amount of display 86 interactions. These metrics may indicate which combinations of presented HMI visualizations were preferred by the operator based on a total quantity of user inputs and/or a total quantity of a particular type of user input. A particular type of the user input may correspond to user inputs to a subset of the display 86 which may be correlated to a drop-down menu visualization or a particular button visualization. In some cases, the processor 74 may analyze input data to determine which combinations of keywords caused the relatively lowest total amount of operator interaction time based on a difference between a first time stamp corresponding to a first user input and a second time stamp corresponding to a last user input. The total amount of operator interaction time may correspond to an improved efficiency of information conveyed to the operator which in turn may reduce total resources consumed from presenting the visualizations to the operator.

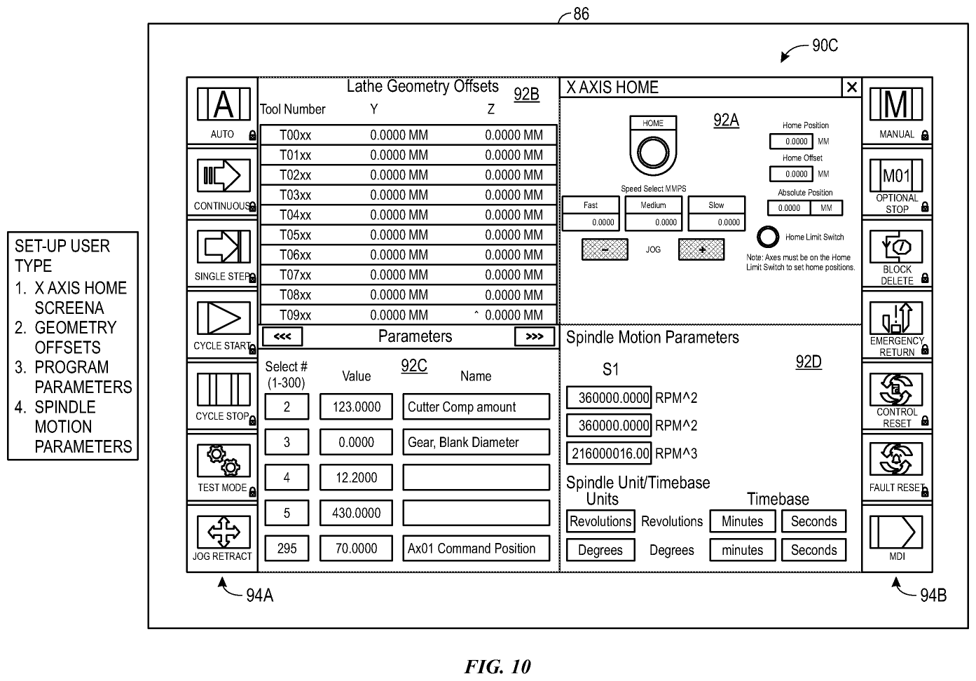

The data in the PP data structure 130 corresponding to the user identifier and/or the user type may be adjusted based on actual operator interactions (e.g., adjusted based user inputs) to anticipate future preferences of that operator. In some cases, the operator may select the keywords from the “Keyword List” 190 and those selections are received by the processor 74 and used to generate the HMI visualization 90B of FIG. 9. The processor 74 may process data in the PP data structure 130 to generate the HMI visualization 90B and bypasses generating the “Keyword List” 190, which may further conserve computing resources. In FIG. 9, each of quadrant visualizations 92 may be respectively changed based on an input to a respective of button visualizations 200 (button visualization 200A, button visualization 200B, button visualization 200C, button visualization 200D). Although FIGS. 10-13 may not specifically depict button visualizations 200, other input visualizations or input devices (e.g., physical input buttons) may receive an indication of a selection or an indication of a request for particular data that the processor 74 may respond to by updating (e.g., trigger an update) of the displayed image content.

Different user types and/or different user identifiers may be associated with different data in the PP data structure 130. Thus, the processor 74 may generate HMI visualization data 186 having a different order of keywords and/or a different HMI visualization 90 from those illustrated in FIGS. 8-9. Indeed, the processor 74 may adjust the “Keyword List” 190 HMI visualization data 168 to read “X Axis Home Screen,” “Geometry Offsets,” “Program Parameters,” “Spindle Motion Parameters,” for a set-up user type. The HMI visualizations 90 of FIGS. 10-13 may illustrate different examples of visualizations generated by the processor 74 based on data stored in data structures 110 and 130.

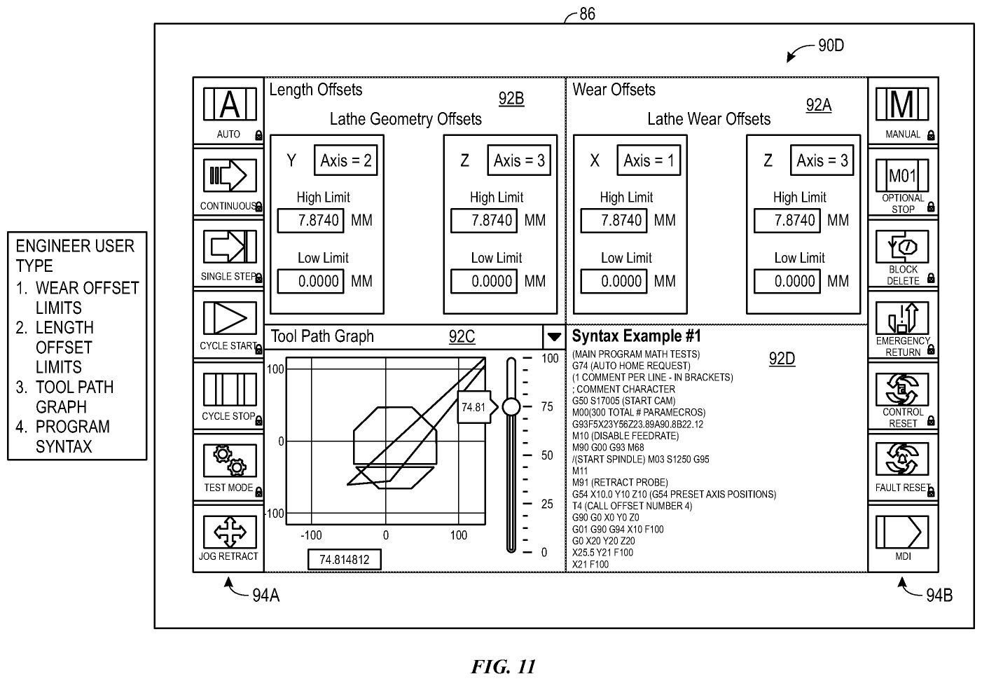

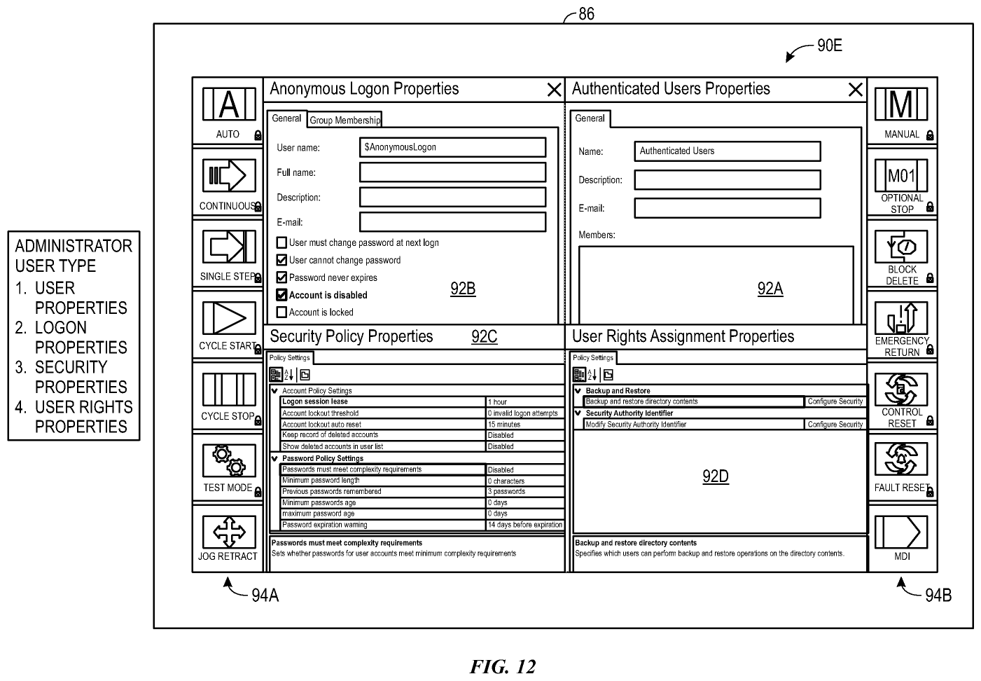

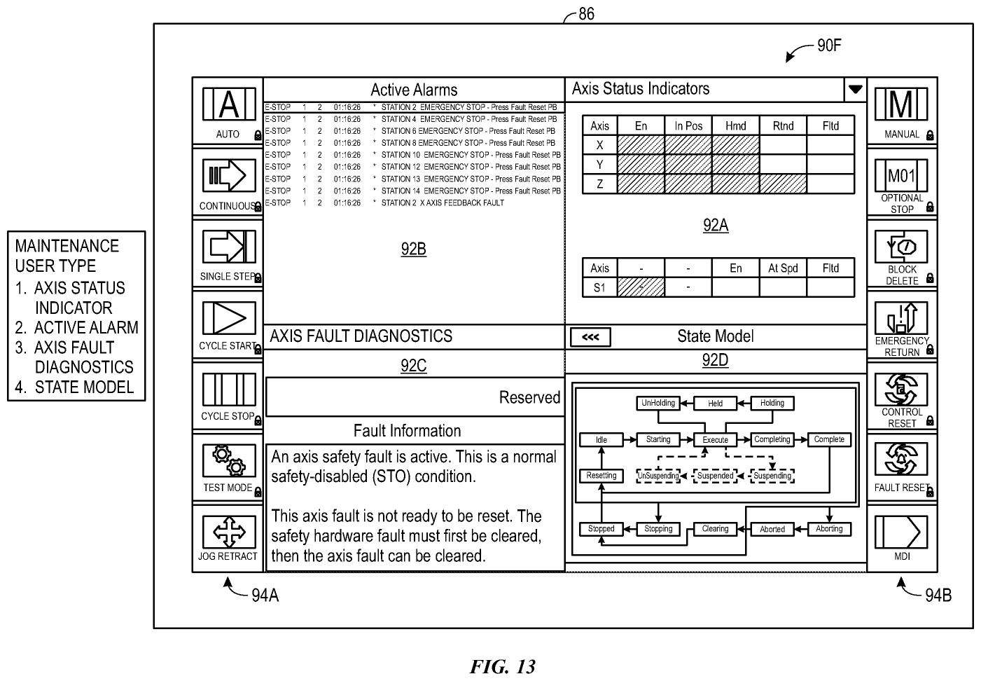

To elaborate on an example HMI visualization 90 for the set-up user type, FIG. 10 is a diagrammatic representation of a third HMI visualization of FIGS. 6-7, the third HMI visualization corresponding to the set-up user type. To elaborate on an example visualization for the engineer user type, FIG. 11 is a diagrammatic representation of a fourth HMI visualization of FIGS. 6-7, the fourth HMI visualization corresponding to the engineer user type. To elaborate on an example visualization for the administrator user type, FIG. 12 is a diagrammatic representation of a fifth HMI visualization of FIGS. 6-7, the fifth HMI visualization corresponding to the administrator user type. To elaborate on an example visualization for the maintenance user type, FIG. 13 is a diagrammatic representation of a sixth HMI visualization of FIGS. 6-7, the sixth HMI visualization corresponding to the maintenance user type. For ease of reference, FIGS. 10-13 are described together herein.

In each of the FIGS. 9-13, the display 86 includes the four quadrant visualizations 92. In each of the FIGS. 10-13, each respective quadrant visualizations 92 corresponds to different image content. The processor 74 in each of these different examples has generated HMI visualization data 168 (e.g., image data) that corresponds to the accessing operator by their corresponding user identifier, user type, or both based on what preference data and associations between data is stored in the UT data structure 110 and the PP data structure 130.

When an operator logs in with a user identifier associated with the set-up user type, the HMI 52 may cause the display 86 to present the HMI visualization 90C, which may represent information prioritized to be presented to that operator based on data associated with the user identifier and/or the set-up user type in the PP data structure 130. The HMI 52, via the processor 74, generates the HMI visualization data 168 to cause the image content presented by the display 86 to prioritize presentation of “X Axis Home Screen” content, “Geometry Offsets” content, “Program Parameters” content, and “Spindle Motion Parameters” content when presenting the HMI visualization 90C.

When an operator logs in with a user identifier associated with the engineer user type, the HMI 52 may cause the display 86 to present the HMI visualization 90D, which may represent information prioritized to be presented to that operator based on data associated with the user identifier and/or the engineer user type in the PP data structure 130 . . . . The HMI 52, via the processor 74, generates the HMI visualization data 168 to cause the image content presented by the display 86 to prioritize presentation of “Wear Offset Limits” content, “Length Offset Limits” content, “Tool Path Graph” content, and “Program Syntax” content when presenting the HMI visualization 90D.

When an operator logs in with a user identifier associated with the administrator user type, the HMI 52 may cause the display 86 to present the HMI visualization 90E, which may represent information prioritized to be presented to that operator based on data associated with the user identifier and/or the administrator user type in the PP data structure 130 . . . . The HMI 52, via the processor 74, generates the HMI visualization data 168 to cause the image content presented by the display 86 to prioritize presentation of “User Properties” content, “Logon Properties” content, “Security Properties” content, and “User Rights Properties” content when presenting the HMI visualization 90E.

When an operator logs in with a user identifier associated with the maintenance user type, the HMI 52 may cause the display 86 to present the HMI visualization 90F, which may represent information prioritized to be presented to that operator based on data associated with the user identifier and/or the maintenance user type in the PP data structure 130. The HMI 52, via the processor 74, generates the HMI visualization data 168 to cause the image content presented by the display 86 to prioritize presentation of “Axis Status Indicators” content, “Active Alarms” content, “Axis Fault Diagnostics” content, and “State Model” content when presenting the HMI visualization 90F.

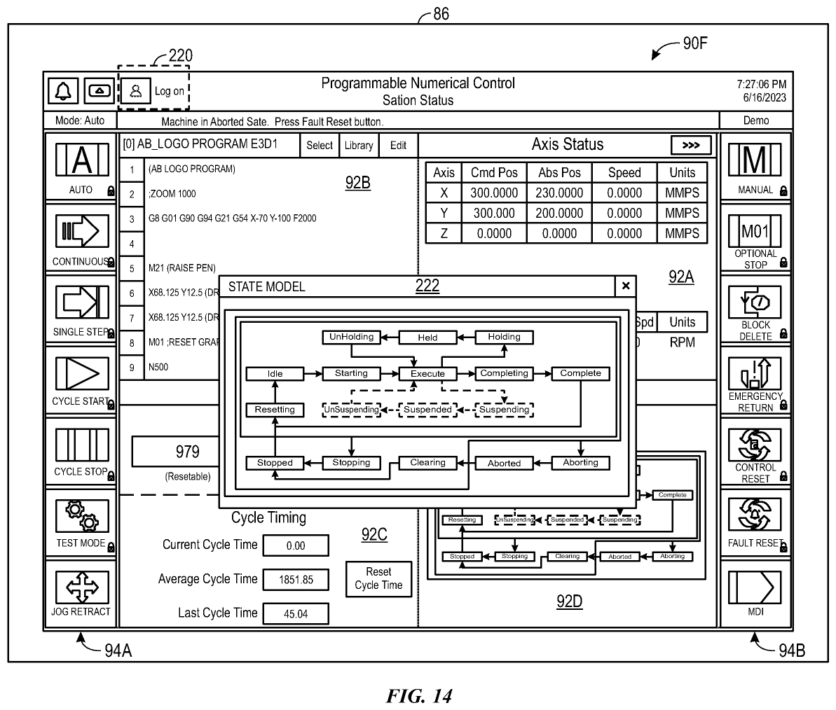

In some cases, the processor 74 may present some content as overlaid on other content when generating HMI visualizations 90, such as when the PP data structure 130 indicates a preference of an operator as such. FIG. 14 is a diagrammatic representation of a seventh HMI visualization of FIGS. 6-7, the seventh HMI visualization corresponding to an overlaid visualization that expands a quadrant of the HMI visualization. Indication 220 illustrates that the processor 74 has yet to verify a user identifier for a session with the HMI 52. Once the user identifier is confirmed (e.g., authenticated) by the processor 74, the indication 220 may be updated to read “Log off.” Thus, FIG. 14 may be an example of content overlaid as a default screen. The processor 74 may generate the HMI visualization data 168 corresponding to a default case based on indications stored in memory 76 and/or based on what an averaged data of the PP data structure 130. In this case, the processor 74 may have determined averaged preference data from the PP data structure 130 that causes the quadrant visualizations 92 to correspond to “Axis Status” content in quadrant 90A, “Program” content in quadrant 90B, “Cycle Timing” content in quadrant 90C, and “State Model” content in quadrant 90D and as overlaid content 222.

As noted above, sometimes the HMI 52 updates the PP data structure 130 based on output preference data generated via the preference processing operation 164 of the processor 74. To elaborate, FIG. 15 is a diagrammatic representation of operations performed by the processor 74 to generate the HMI visualization data 186 of FIG. 6 and output preference data 230 to change data stored in the PP data structure 130 based on input data 166.

The processor 74 may use first level data and second level data when generating the HMI visualization data 168. The processor 74 may generate the second level data based on the input data 166, and the second level data may correspond to some of example input data 162. In some cases, the input data 162 is received from the computing device 66 and/or via the cloud-based computing system 68. Second level data may be related to other determinations made regarding other industrial automation equipment and applied to the HMI 52 to be used relative to the industrial automation equipment 56. Input data 162 and/or 166 may be identified and processed based on the preference processing operation 164. In some cases, the input data 166 includes indications of inputs (e.g., tactile inputs), indications of selections corresponding to the inputs, and indications of timestamps of those inputs. These indications of input data 166 may be collected over time and transmitted as a batch of data to the processor 74. In some cases, the input data 166 may be collected and transmitted in real time. The PP data structure 130 may be updated based on the first level data and/or the second level data based on the processor 74 transmitting the output preference data 230 to the PP data structure 130. The processor 74 may associate the output preference data 230 to the user identifier and/or the user type in the memory 76, such as via writing the output preference data 230 in association with the user identifier when storing in the PP data structure 130.

To generate the HMI visualization data 168, the processor 74 may receive the input data 176. The input data 176 may include user identifier that the processor 74 may use to determine a corresponding user type, as described above. In some cases, the input data 176 corresponds to second level data, such as data related to a second filter. The processor 74 may generate second level of data based on input data 166 received while the HMI visualization data 168 is presented.

For example, the processor 74 may generate the HMI visualization data 168 based on data stored in the PP data structure 130 at a first time. While content is presented via the display 86 based on that HMI visualization data 168, the processor 74 may receive input data 166 as received via the display relative to the content. The processor 74 may process this additionally received input data 166 to analyze what types of changes and timings of the changes are made to the content to adjust the presentation priority data stored in the PP data structure 130 for future generation operations. In this way, presentation priority data stored in the PP data structure 130 may be iteratively adjusted over time to better change how and what content is presented in response to a user identifier and/or user type. Second level data may include an indication of data used to generate the HMI visualization data 168 presented on the display 86 while the additionally received input data 166 was received (e.g., identified user type data 232, presented content indications and/or keywords 234). Second level data may also include indications of a number of inputs are received via HMI 52 while respective screen presented (data 236), a screen selected by an operator (data 238), a percentage of time a selected screen is on the display 86 (data 240), a number of times that a particular screen is selected, quadrant placement within a dashboard (e.g., GUI content) presented by the HMI visualization data 168 (data 244), operator selected quadrant placement of the respective HMI visualization, a timeframe used by an operator to interact with a selected HMI visualization (e.g., first three minutes, each hour) (data 246), one or more input sequences associated with content changes between screen selections or HMI visualizations (e.g., a first series of inputs associated with a first user type indicate a selection a first set of four HMI visualizations then later a second series of inputs associated with the first user type indicates a selection of a second set of four HMI visualizations) (data 248), a random screen selected by a respective user type (data 250), a top N number of screen selections (e.g., top ten screen selections) (data 252), which screen is set as a default screen to be presented (data 254), saved user preferences associated with that user identifier (data 256), recommended screen pairings (e.g., quadrant-to-screen content assignments) based on user type and/or user identifier (data 258), or the like.

The data 236 may indicate a number of inputs received via the HMI 52 while a respective screen is presented. The processor 74 may correlate the number of inputs to a relative interest level in the content associated with that respective screen. If the inputs received are an instruction to change the respective screen presented to a different screen, the number of inputs received may correspond to a lower likelihood that the same operator or a different operator of the same user type may want to see that original respective screen. The data 236 may be related to the data 238. The data 238 may indicate one or more screens selected by an operator and/or indicate which screens were exchanged for what other screens. Based on the screens selected, the HMI 52 may record a percentage of time that a respective selected screen is presented via the display 86 as the data 240. The data 244 may indicate a number of times that a particular screen is selected and/or the quadrant placement within a dashboard (e.g., GUI content) of the particular screen as caused by the HMI visualization data 168. In this way, input may be received via the display 86 or an input device of the HMI 52 and the input may be compared to the HMI visualization data 168 to identify which portion of the image content the input was directed toward. Based on this, the processor 74 may log a first count that tracks a number of times that a respective screen option is selected for presentation via the display 86 and/or a second count that tracks a number of times that a respective screen options is rearranged in its presentation to a different quadrant. Based on these counts, the processor 74 may determine which subset of screens that operator is more interested in viewing and which quadrant that operator may prefer to see that screen presented within. The processor 74 may associate the counts with the user identifier of the operator and/or the user type of the operator in the PP data structure 130. The processor 74 identify a trend between different user identifiers of one or more user types relative to access patterns or preferences, such as by determining that a threshold number of user identifiers are accessing at least some of the screens according to similar access patterns or preferences. When a trend is identified, the processor 74 may compare properties or metadata associated with the user identifiers, such as the user type, a time of day, timeframes of accesses, what operational state the industrial automation equipment 56 is operated in when the accesses occurred, or the like to try to determine properties similar among the accesses. The processor 74 may monitor for these properties to predict when to generate the HMI visualization data 168 corresponding to the access trends previously identified.

The data 246 may correspond to an input, a timestamp of that input, and a location of that input to the display 86 or other input device. The processor 74 may correlate the location of that input to a portion of content presented via the display 86. The data 242 may indicate a number of inputs to respective portions of content based on the correlated location data. The data 246 may indicate a time frame of inputs to a selected screen or portion of content presented via the display 86 as part of a screen. The time frame of the inputs may be determined based on the processor 74 determining a timestamp of a first input a timestamp of a last input and identifying a difference in time between the first and last inputs. The data 246 may indicate a time frame between inputs, such as one minute between inputs or 10 seconds between inputs, which may correspond to a relative interest level of information presented via the content (e.g., where relatively long intervals may indicate that the operator was reading the content longer and thus that content is more relevant to that operator). The data 248 may be generated based on the correlated locations of the various inputs. Indeed, the correlated locations may indicate selected quadrant placements of screens of the respective HMI visualization and/or whether these screen selections were changed via user input data 166. In this way, the correlated locations of inputs and timing of the inputs may indicate one or more input sequences associated with content changes between screen selections. For example, a first series of inputs associated with a first user type may indicate a selection a first set of four HMI visualizations and a second series of inputs associated with the first user type may indicate a selection of a second set of four HMI visualizations. Together, the first series of inputs and the second series of inputs may indicate an input sequence that causes the transition from the first set of four HMI visualizations to the second set of four HMI visualizations.

Input data 166 may also be used by the processor 74 to determine the different types of screens selected by a respective user type and from that subset of screens that the an operator has actually selected, the processor 74 may select a random one of the subset to indicate as the data 250. Presenting a random screen previously selected as part of the HMI visualization data 168 may remind an operator that the screen exists as an option when previously the operator may overlook that option. The processor 74 may receive the indication of the correlated location to screen content and determine that the input data 166 selected a respective screen as opposed to interacting with content presented. When the input data 166 was used to select a screen, the processor 74 may associate the user identifier with an indication of the type of the selected screen in memory 76. By doing so, the processor 74 may generate a record of which screen subset that operator has selected and/or interacted with. The processor 74 may refer to the record of past screen selections when determining which screens to present as part of a different access attempt by the operator. Sometimes the processor 74 may determine to repeat a previous screen with updated information for a current operation of the industrial automation equipment. Sometimes the processor may determine to present a new screen not previously interacted with or accessed by the operator. Examples of a type of selected screen are show in FIGS. 9-14, such as “Active Alarms” screen of FIG. 13 or “State Model” screen of FIG. 14. In conjunction with storing a record of screens previously accessed, the processor 74 may store a count of accesses associated with the screens previously accessed. For example, the PP data structure 130 may store an indication of a user identifier, a subset of screens presented while that user identifier was logged into an HMI 52 as part of a session, and a count of accesses of each screen of the subset of screens. From this data, the processor 74 may identify, as the data 252, a top N number of screen selections that were the most frequently accessed in a session involving a respective user identifier (e.g., top ten screen selections). The processor 74 may select one of the screens to present as a default screen to be presented, an indication of the selection may correspond to the data 254. The processor 74 may select the default screen as the screen that is the most frequently accessed by a respective user identifier or user type, which may be determined based on the count of accesses of each screen of the subset of screens stored in the PP data structure 130. In some cases, the processor 74 may receive as the input data 166 an indication of a save instruction and an indication of a preference input received while the user identifier HMI 52 access session. The processor 74 may, in response to the save instruction, write the preference input to memory 76 in association with that user identifier as the data 256. The processor 74 at a later time may reference the preference input in memory when that user identifier requests to access the HMI 52 to present content less likely to be corrected by additional input data 166 (and thus may be more likely to cause more efficient content presentation operations). In some cases, the processor 74 may read the data 258 from memory 76. The data 258 may include an indication of recommended screen pairings, such as quadrant-to-screen content assignments based on user type and/or user identifier. As noted above, data 258 and/or other of the data 232-258 may be stored in the memory 76 or generated by the computing device 66, by the control/monitoring device 54, by the cloud-based computing system 68 via the control/monitoring device 54, or the like.

In some cases, the input data 162 may be scaled or adjusted by corresponding gain inputs. Adjusting the different subsets of input data 162 respectively via the gain inputs may enable a change in a relative importance of that respective input data 162 to the generated output preference data 230.

To elaborate, FIG. 16 is a diagrammatic representation of operations performed by the processor 74 to generate the output preference data 230 based on input data 166 and gain data 270. The gain data 270 may indicate a gain adjustment corresponding to a priority of input data 162, and thus may change a weight of influence that respective input data 162 has on the HMI content determined via preference processing operation 164. The gain data 270 may be changed over time by the processor 74 in response to iterative testing of combinations of gain adjustments and determining which results in a more efficient HMI visualization determination via preference processing operation 164. In some cases, the processor 74 may receive gain data 270 indicative of the gain adjustment to be applied. The gain data 270 may correspond to other industrial automation systems external to industrial automation system 10 and thus represent a combination of gain adjustment that may have been deemed efficient from another facility and shared with the processor 74. This example gain data 270 transmission may occur based on the computing device 66 and/or the cloud-based computing system 68 communicating with similar components at a different industrial automation system and transmitting to the HMI 52 via the control/monitoring device 54. The gain data 270 may be adjusted by the operator. Based on the gate data 270, the processor 74 may generate the HMI visualization data 168 based on reading gain data 270 associated with one or more of the presentation priority data of the PP data structure 130. The processor 74 may select a subset of screens to present via the display 86 while the user identifier is logged into the HMI 52 based on the gain data 270, the presentation priority data, the user identifier, and the user type.

In some systems, the HMI 52 may exclude the processor 74 and the memory 76. The HMI 52 may communicate with a local controller, such as the control/monitoring device 54 (e.g., programmable logic controller (PLC)), to process input data 166 and generate HMI visualization data 168. One advantage from offloading these processing operations to a local controller may be that the local controller may interconnect differently (e.g., more directly, through a different communication protocol layer) and/or with different permissions into the industrial automation control system 10 than the HMI 52. Inputs or changes to the HMI visualization data 168 made via the local controller may be propagated throughout some or all of the industrial automation system 10. For example, the local controller may transmit a presentation priority determined for a first user identifier upstream to a higher level computing device 66 (e.g., a computer in a central control room) such that when the computing device 66 receives a login attempt corresponding to the first user identifier, the computing device 66 generates the HMI visualization data 168 that corresponds to a presentation priority determined based on that previous input data 166 received in association with the first user identifier. Sharing determined presentation priorities and adjusting HMI visualization data 168 and/or other generated content based on the shared presentation priority data may reduce an aggregate amount of computing resources dedicated to presenting or correcting presentation of HMIs. Since the computing device 66 may present according to the shared presentation priority data, the higher level computing device 66 may generate HMI visualization data 168 with relatively high likelihoods of being the content desired by the operator without receiving more input data 166 beyond the user identifier. This may result in fewer screen toggling-related inputs to correct what information has been presented via a display 86, among other computational resource savings and/or power consumption reductions.

In some cases, the HMI 52 may transmit, via the processor 74, an indication of the subset of screens to the computing device 66 external to the HMI 52 and/or the cloud-based computing system 68. The computing device 66 external to the HMI 52 may generate additional HMI visualization data corresponding to the HMI visualization data 168 for presentation on a display 86 of the computing device 66.

Furthermore, sometimes user presentation priorities may be used in conjunction with HMI templates 160 for a device type. Thus, at block 148, the HMI visualization data 168 may be generated based on a user identifier (e.g., received via the input data 166), corresponding presentation priorities (e.g., in PP data structure 130) for that user identifier and/or a corresponding user type (e.g., indicated in UT data structure 110), a device type associated with metadata accessible by the HMI 52 and/or local control/monitoring device 54 indicating a device type of the industrial automation equipment 56, and an HMI template corresponding to that device type. HMI template 160 may be stored in memory 76.

In some systems, the HMI visualization data 168 may be generated based on what processing circuitry determines as a likely area for inspection. For example, if the industrial automation equipment 56 is in an alarm state, the processor 74 may generate HMI visualization data 168 based on the alarm state, one or more other statuses, sensing data acquired during an operation of the industrial automation equipment 56, or the like. By doing so, the processor 74 may predict which screens of content may be relevant to an operator approaching the HMI 52 to debug operation of the industrial automation equipment 56 and may use these predictions to generate the HMI visualization data 168.

The HMI visualization data 168 may include indications of screens to be presented via the display portions (e.g., quadrant visualizations 92). The screens may be visualization data files generated on a computing device external to the HMI 52 (e.g., the computing device 66) and stored in the HMI 52 (e.g., in memory 76). A design software may be used to generate the visualization files that may include instructions to cause a display to render suitable visualizations that communicate operational data, statuses, or the like associated with an operation of corresponding industrial automation equipment 56. The visualization files may correspond to different industrial automation equipment 56 device types. Different HMI 52 may have access to subsets of visualization files based on its associated industrial automation equipment 56 and a device type of the associated industrial automation equipment 56. The visualization files may be shared via the cloud-based computing system 68 among different industrial automation systems 10 and/or received from third-parties (e.g., industrial automation equipment 56 manufacturers), in which doing so may expedite visualization file development within the industrial automation system 10 and reduce computing resources used to generate such types of visualization files.

Technical effects of the systems and methods described herein may include reducing computing resources consumed by processing circuitry (e.g., of an HMI, of a PLC) when presenting HMI visualizations to a variety of different operators and user types. Computing resources consumed may be reduced by the systems and methods described herein based on the processing circuitry presenting multiple screens of HMI visualizations via two or more portions of the display (e.g., quadrants, halves, thirds) since fewer inputs may be received to toggle between screens of information, where each toggle may consume computing resources to load that content of the selected screen. Computing resources consumed may be reduced by the systems and methods described herein by the processing circuitry presenting HMI visualizations that indicate each available screen that may be loaded at least in part by causing fewer inputs to be received from an operator toggling, where the toggling may be between various screens attempting to determine a scope of available content and information of that respective HMI. Furthermore, computing resources consumed may be reduced based on the processing circuitry predicting which content may be desired to be viewed by a respective operator based on a received indication of user identifier that the processing circuitry may identify an association to a user type in memory. The processing circuitry may perform content prediction based on iterative analysis operations performed over time and across multiple types of users and/or multiple user identifiers to determine trends of content access to improve how and what content is presented to different types of operators and different operators. The content prediction operations described herein may reduce computing resources consumed by the processing circuitry since fewer inputs may be received to toggle between screens of information, where each toggle may consume computing resources to load that content of the selected screen. Even further computing resource reduction may occur when systems and methods are applied to other types of HMIs throughout an industrial automation system. In this way, additional reductions in computing resource consumption may occur when presentation preferences for a respective user identifier and/or user type are determined at a first processing circuitry and transmitted through communicative couplings within the industrial automation system to enable other processing circuitry to cause presentation of content according to the same presentation preferences as identified at the first processing circuitry.

While the present disclosure may be susceptible to various modifications and alternative forms, specific embodiments have been shown by way of example in the drawings and have been described in detail herein. However, it should be understood that the present disclosure is not intended to be limited to the particular forms disclosed. Rather, the present disclosure is intended to cover all modifications, equivalents, and alternatives falling within the spirit and scope of the present disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A method comprising:
receiving, via a processor of a human machine interface (HMI) communicatively coupled to an industrial automation device, an indication of a user identifier from an input device, wherein the HMI is configured to present one or more visualizations that communicate sensed data, a status, or both associated with an operation of the industrial automation device;
identifying, via the processor, a user type corresponding to the user identifier based on a user type data structure, wherein the user type data structure is configured to characterize a dataset stored in a memory component accessible to the processor, and wherein each of a plurality of user identifiers are categorized with respect to a plurality of user types comprising an operator user type, a set-up user type, an engineer user type, a maintenance user type, an administrator user type, or any combination thereof;
generating, via the processor, HMI visualization data based on the user type, the user identifier, and a presentation priority data structure, wherein the presentation priority data structure comprises presentation priority data corresponding to the user type and the user identifier; and
sending, via the processor, a control signal to a display to cause presentation of the HMI visualization data.

2. The method of claim 1, wherein generating the HMI visualization data based on the user type comprises determining a subset of presentation priority data corresponds to preferences determined by the processor while the user identifier was logged into the HMI, wherein the subset of presentation priority data is different from another subset of presentation priority data corresponding to a different user type, a different user identifier, or both.

3. The method of claim 1, comprising reading the presentation priority data structure, wherein the presentation priority data comprises:
an indication of a percentage of time a respective screen is presented in association with the user identifier;
an indication of a quadrant placement of a respective screen in association with the user identifier;
an indication of a frequency of inputs received via a respective screen in association with the user identifier;
an indication of a total set of screens selected in association with the user identifier; or
any combination thereof.

4. The method of claim 3, wherein generating the HMI visualization data comprises:
reading gain data associated with each of the presentation priority data; and
selecting a subset of screens to present via the display while the user identifier is logged into the HMI based on the gain data, the presentation priority data, the user identifier, and the user type.

5. The method of claim 4, wherein the subset of screens corresponding to the user identifier is different from another subset of screens previously selected in association with another user identifier being logged into the HMI.

6. The method of claim 4, comprising transmitting, via the processor, an indication of the subset of screens to a computing device external to the HMI, wherein the computing device external to the HMI is configured to generate additional HMI visualization data corresponding to the HMI visualization data for presentation on a display of the computing device.

7. A tangible, non-transitory, computer-readable medium comprising instructions that, when executed by a processor, causes a human machine interface (HMI) terminal to perform operations comprising:
receiving an indication of a first user identifier from an input device of an industrial automation device while a first visualization is presented that communicates sensing data, a status, or both associated with an operation of the industrial automation device;
identifying a first user type corresponding to the first user identifier based on a user type data structure, wherein the user type data structure is configured to characterize a dataset stored in a memory component accessible to the processor, and wherein each of a plurality of user identifiers are categorized with respect to a plurality of user types comprising an operator user type, a set-up user type, an engineer user type, a maintenance user type, an administrator user type, or any combination thereof;
generating first HMI visualization data configured to cause presentation of a second visualization generated based on the first user type, the first user identifier, and a presentation priority data structure, wherein the presentation priority data structure comprises first presentation priority data corresponding to the first user type and the first user identifier; and
sending a control signal to a display to cause presentation of the first HMI visualization data.

8. The tangible, non-transitory, computer-readable medium of claim 7, the operations comprising:
receiving an indication of a second user identifier from the input device while the second visualization is presented; and
generating second HMI visualization data configured to cause presentation of a third visualization based on the second user identifier, a second user type, and the presentation priority data structure that comprises second presentation priority data corresponding to the second user type and the second user identifier, wherein the second visualization and the third visualization are different.

9. The tangible, non-transitory, computer-readable medium of claim 7, wherein the second visualization corresponds to the first user type comprising the operator user type, wherein the second visualization prioritizes presentation at least a production data screen over one or more other screens of a plurality of screens based on the operator user type.

10. The tangible, non-transitory, computer-readable medium of claim 7, wherein the second visualization is configured to sort indications of keywords configured to be presented as part of a keyword list visualization based on the first user type and a plurality of indications of screens selected to be presented for the first user type.

11. The tangible, non-transitory, computer-readable medium of claim 7, wherein the first presentation priority data comprising:
an indication of a percentage of time a respective screen is presented in association with the first user identifier;
an indication of a quadrant placement of a respective screen in association with the first user identifier;
an indication of a frequency of inputs received via a respective screen in association with the first user identifier;
an indication of a total set of screens selected in association with the first user identifier; or
any combination thereof.

12. The tangible, non-transitory, computer-readable medium of claim 7, the operations comprising determining the second visualization to comprise a second set of screens to be different from a first set of screens of the first visualization.

13. The tangible, non-transitory, computer-readable medium of claim 12, wherein the second set of screens are respectively presented via one of four quadrants of the display, and wherein each screen of the second set of screens corresponds to a respective visualization data file.

14. A tangible, non-transitory, computer-readable medium comprising instructions that, when executed by a processor, causes an industrial control device to perform operations comprising:
generating first visualization data configured to cause presentation of a first visualization comprising a first set of screens, wherein the first visualization communicates sensing data, a status, or both associated with an operation of an industrial automation device;
receiving an indication of a user identifier from an input device of an industrial automation device while the first visualization is presented;
identifying a user type corresponding to the user identifier based on a user type data structure, wherein the user type data structure is configured to characterize a dataset stored in a memory component accessible to the processor, and wherein each of a plurality of user identifiers are categorized with respect to a plurality of user types comprising an operator user type, a set-up user type, an engineer user type, a maintenance user type, an administrator user type, or any combination thereof;
determining a second set of screens based on the user type, the user identifier, and a presentation priority data structure, wherein the presentation priority data structure comprises presentation priority data corresponding to the user type and the user identifier; and
generating second visualization data configured to cause presentation of a second visualization comprising the second set of screens.

15. The tangible, non-transitory, computer-readable medium of claim 14, the operations comprising determining the second set of screens to be different from the first set of screens based on the presentation priority data.

16. The tangible, non-transitory, computer-readable medium of claim 14, the operations comprising:
reading a memory to access the presentation priority data structure; and
generating second level input data based on the user type, the user identifier, and indication of a plurality of input selections and respective timestamps of each input selection of the plurality of input selections that were received during a session corresponding to the user identifier.

17. The tangible, non-transitory, computer-readable medium of claim 16, the operations comprising generating the presentation priority data to overwrite preexisting presentation priority data stored in the presentation priority data structure in association with the user identifier, the user type, or both.

18. The tangible, non-transitory, computer-readable medium of claim 16, the operations comprising generating the second level input data at least in part by:
comparing the plurality of input selections and the respective timestamps of each input selection of the plurality of input selections to a previously received plurality of inputs selections and respective timestamps of each input selection of the previously received plurality of inputs selections;
determine a number of times that a first screen is selected during the session corresponding to the user identifier;
determine that the number of times that the first screen is selected during the session corresponding to the user identifier crosses a threshold number of selections;
determine that a rate between selections of the first screen is less than a threshold rate; and
generate the second level input data to indicate that the first screen is a preferred screen of a plurality of screens based on the rate being less than a threshold rate and the number of times that the first screen is selected crosses a threshold number of selections.

19. The tangible, non-transitory, computer-readable medium of claim 16, the operations comprising generating the second level input data to comprise one or more of:
a percentage of time a respective screen is presented;
a quadrant placement of a respective screen;
a frequency of inputs received via a respective screen;
a total set of screens selected during the session corresponding to the user identifier; or
any combination thereof.

20. The tangible, non-transitory, computer-readable medium of claim 16, wherein the industrial control device comprises a human machine interface.
